(19) United States
(12) Patent Application Publication
(10) Pub. No.: US 2015/0116819 A1
(43) Pub. Date: Apr. 30, 2015

(54) ZOOM LENS

(71) Applicant: TAMRON CO., LTD., Saitama-shi (JP)

(72) Inventor: Lai WEI, Saitama-shi (JP)

(73) Assignee: TAMRON CO., LTD., Saitama-shi (JP)

(21) Appl. No.: 14/513,423

(22) Filed: Oct. 14, 2014

(30) Foreign Application Priority Data
Oct. 24, 2013 (JP) 2013-220934

(51) Int. Cl. G02B 13/14; G02B 15/177; G02B 13/00; G02B 15/16

(52) U.S. Cl. CPC G02B 13/146; G02B 15/161; G02B 15/177; G02B 13/009; G02B 13/002
USPC 359/354

(57) ABSTRACT

A zoom lens includes sequentially from an object side a first lens group having a negative refractive power; an aberture stop; and a second lens group having a positive refractive power. The second lens group is moved along an optical axis toward the object side to zoom from a wide angle edge to a telephoto edge. The first lens group is moved along the optical axis toward en image side to correct image plane variation accompanying zooming. The second lens group includes sequentially from the object side, a positive lens having at least one aspheric surface, and a cemented lens configured by a negative lens, a positive lens, and a negative lens. The zoom lens satisfies a conditional expression (1) 1.8<D2/Z<2.3, where D2 indicates an amount of movement of the second lens group, accompanying zooming from the wide angle edge to the telephoto edge, and Z indicates a zoom ratio.

### BACKGROUND OF THE INVENTION

1. Field of the Invention

The present invention relates to a zoom lens that can be used for video cameras, digital still cameras, etc. and that is particularly suitable for surveillance cameras that capture images during the day and at night.

2. Description of the Related Art

Conventionally, surveillance cameras such as those for closed circuit television (CCTV) are widely used for monitoring unmanned facilities. Many surveillance cameras capture images using visible light during the day and near infrared light at night. Consequently, lens systems that can be used irrespective of whether it is day or night, i.e., lens systems that can handle light of both the visible light range and the near infrared light range are demanded for surveillance cameras.

Typically, in a lens system designed for use with visible light, chromatic aberration particularly occurs in the near infrared light range and when images are captured by near infrared light at night, the images are out of focus. Thus, a lens system that can favorably correct chromatic aberration over a wide spectrum such that the focal point is constant for light of a wide wavelength range, from the visible light range to the near infrared light range is preferable as a lens system mounted on a surveillance camera. A lens that enables zooming, is compact, and has favorable optical performance for a large aperture ratio is even more preferable.

Conventionally, zoom lenses have been proposed that can handle light of the visible light range to the near infrared light range, enabling mounting to a surveillance camera (for example, refer to Japanese Patent Application Laid-Open Publication Nos. 2009-230122 and 2011-175174).

The optical zoom system disclosed in Jaoanese Patent Aoplication Laid-Open Publication No. 2009-230122 includes sequentially from an object side facing toward an object, a first lens group having a negative refractive power, diaphragm, and a second lens group having a positive refractive power. The first lens group includes, sequentially from the object side, a negative meniscus lens, a negative meniscus lens, a biconcave lens, and a positive Lens. The second lens group includes 5 simple lenses.

The zoom lens disclosed in Japanese Patent Application Laid-Open Publication No. 2011-175174 includes sequentially from the object side, a first lens group having a negative refractive power, a diaphragm, and a second lens group having a positive refractive power. The firil lens group includes sequentially from the object side, a negative meniscus tens, a biconcave lens, and a positive lens. The second lens group includes 3 cemented lenses.

In recent years, in addition to handling wavelengths of a wide spectrum from the visible light range to the near infrared light range, there has been demand for surveillance camera lens systems to be able to zoom. Furthermore, there is demand for lens systems to have a large aperture ratio to enable vivid images to be captured even in dark places. Pixel counts of image sensors (CCD, CMOS, etc.) have drastically increased recently and lens systems are also demanded that: can handle megapixel images, which enable even finer features of a subject to be seen.

Meanwhile, consequent to the spread of compact, Monitoring dome cameras, demand for compact lens systems that can be accommodated in within the dome is also rising. Therefore, a compact lens system that over the entire zoom range, can favorably correct various types of optical aberration occurring with respect to light of the visible light range to the near infrared light range and that has extremely high optical performance is demanded as a lens system for a surveillance camera that can capture megapixel images.

Nonetheless, the optical zoom system disclosed in Japanese Patent Application Laid-Open Publication No. 2009-230122 has a zoom ratio of 2 times at most, which is insufficient. An attempt to realize a high zoom ratio and large aperture ratio for the optical zoom system disclosed An Japanese Parent Application Laid-Open Publication No. 2009-230122 would arise in a significant problem, where high optical performance on a level enabling the handling of megapixels becomes diffiCult to obtain.

The zoom lens disclosed in Japanese Patentt. Application Laid-Open Publication No. 2011-175174 has high optical performance capable of handling megapixels; however, the overall length is 65 mm or more and therefore, accommodation of the lens system in the dome for a compact surveillance camera is difficult.

### SUMMARY OF THE INVENTION

It is an object of the present invention to at least solve the above problems in the conventional technologies.

A zoom lens according to one aspect of the present invention includes sequentially from an object side a first lens group having a negative refractive power; an aperture stop; and a second lens group having a positive refractive power. The second lens group is moved along an optical axis toward the object side to zoom from a wide angle edge to a telephoto edge. The first lens group is moved along the optical axis toward an image side to correct image plane variation that accompanies zooming. The second lens group includes sequentially from the object side, a positive lens having at least one aspheric surface, and a cemented lens configured by a negative lens, a positive lens, and a negative lens. The zoom lens satisfies a conditional expression (1) 1.8<D2/Z<2.3, where D2 indicates an amount of movement of the second lens group, accompanying the zooming from the wide angle edge to the telephoto edge, and Z indicates a zoom ratio (focal length at telephoto edgefocal length at wide angle edge).

### BRIEF DESCRIPTION OF THE DRAWINGS

FIG. 1 is a cross sectional view (along the optical axis) of a zoom lens according to a first embodiment;

FIG. 2 is a diagram of various types of aberration occurring in the zoom lens according to the first embodiment;

FIG. 3 is a cross sectional view (along the optical axis) of the zoom lens according to a second embodiment;

FIG. 4 is a diagram of various types of aberration occurring in the zoom lens according to the second embodiment;

FIG. 5 is a cross sectional view (along the optical axis) of the zoom lens according to a third embodiment;

FIG. 6 is a diagram of various types of aberration occurring in the zoom lens according to the third embodiment;

FIG. 7 is a cross sectional view (along the optical axis) of the zoom lens according to a fourth embodiment; and

FIG. 8 is a diagram of various types of aberration occurring in the zoom lens according to the fourth embodiment.

### DETAILED DESCRIPTION OF THE PREFERRED EMBODIMENTS

Preferred embodiments of a zoom lens according to the present invention will be described in detail.

A zoom lens according to the present invention includes sequentially from the object side, a first lens group having a negative refractive power, an aperture stop prescribing a given aperture, and a second lens group having a positive refractive power. The zoom lens zooms from a wide angle edge to a telephoto edge by moving the second lens group along the optical axis and toward the object side. By moving the first lens group along the optical axis, the zoom lens further corrects image plane variation (imaging position) that accompanies zooming.

One object of the present invention is to provide a zoom lens that is compact and achieves a high zoom ratio and further has high optical performance, enabling use with a megapixel image sensor of 1 million pixels or more. Another object is to provide a zoom lens that achieves a large aperture ratio and has high optical performance, enabling over the entire zoom range, favorable correction of various types of aberration occurring with respect to light of the visible light range to the near infrared light range. Thus, to achieve such objects, the following conditions are set as indicated below.

The second lens group includes sequentially from the object side, a positive lens having at least 1 aspheric surface and a cemented lens formed by a negative lens, a positive lens, and a negative lens. In the second lens group, the positive lens disposed farthest on the object side has an aspheric surface, enabling favorable correction of spherical aberration occurring with the large aperture ratio. Further, arrangement of the cemented lens in the second lens group enables correction of chromatic aberration.

In addition, the following condition is preferably satlisfied, where D2 is the amount ot movement of the second lens group, accompanying zooming from the wide angle edge to the telephoto edge, and Z is the zoom ratio (focal length at telephoto edgefocal length at wide angle edge).

1.8<D2/Z<2.3 (1)

Conditional expression (1) prescribes a suitable stroke range of the second lens group, accompanying zooming. Satisfaction of conditional expression (1) enables the stroke range of the second lens group, accompanying zooming to be suppressed, thereby facilitating reduction in the overall length of the optical system while realizing a high zoom ratio and enabling high optical performance to be obtained.

Below the lower limit of conditional expression (1), although advantageous ir reducing the size of the optical system, a problem arises in that correction of sphedcal aberration and coma occurring at the wide angle edge becomes particularly difficult and optical performance drops. On the other hand, above the upper limit of conditional expression (1), the amount of movement of the second lens group accompanying zooming increases, whereby reductions in the size of the optical system becomes difficult.

By satisfying conditional expression (1) within the following range, even more favorable results can be expected.

2<D2/Z<2.3 (1a)

By satisfying the range prescribed by conditional expression (1a), a zoom lens can be implemented that is compact and that has even betLer optical performance.

Further, in the zoom lens according to the present invention, the following condition is preferably satisfied, where ud2p is the Abbe number for the d-line of the positive lens configuring the cemented lens of the second lens group and ud24 is the Abbe number for the d-line of the negative lens farthest on an image side in the cemented lens of the second lens group.

υd2p>80 (2)

0.6<υd22υd24<1 (3)

Conditional expression (2) prescribes a condition for favorably correcting over the entire zoom range, chromatic aberration occurring with respect to light of the v sible light range to the near infrared light range. By forming the positive lens configuring the cemented lens disposed in the second lens group, of an extraordinary low dispersion material that satisfies conditional expression (2), over the entire zoom range, chromatic aberration occurring with respect to light of the visible light range to the near infrared light range can be favorably corrected. Below the lower limit of conditional expression (2), the correction of chroMatic aberration occurring with respect to light of the visible light range to the near infrared light range becomes difficult over the entire zoom range.

Conditional expression (3) prescribes a condition for favorably correcting chromatic aberration that becomes conspicuous over the entire zoom range, accompanying the increased aperture ratio. Below the lower limit of conditional expression (3), the correction of chromatic aberration occurring at: the telephoto edge becomes difficult. On the other hand, above the upper limit of conditional expression (3), the correction of chromatic aberration occurring at the wide angle edge becomes difficult.

By satisfying conditional expression (3) within the following range, even more favorable results can be expected.

0.7<υd22/υd24<0.9 (3a)

By satisfying the range prescribed by conditional expression (3a), chromatic aberration that becomes conspicuous over the entire zoom range, accompanying the increased aperture ratio, can be more favorably corrected.

Further, in the zoom lens according to the present invention, arrangement of a positive lens on the image side of the cemented lens in the second lens group is preffer, In this case, the fol towing condition is preferably satisfied, where Dp is an interval between the cemented lens of the second lens group and the positive lens disposed on the image side of the cemented lens and L2 is the overall length of the second lens group.

0.02<Dp/L2<0.15 (4)

Conditional expression (4) prescribes a condition for realizing favorable correction of various types of aberration including field curvature. By satisfying conditional expression (4), the overall length cf the second lens group can be reduced and a proper balance of the Petzval sum in second lens group can be maintained while enabling favorable correction of various types of aberration.

Below the lower limit of conditional expression (4), in second lens group, the Petzval sum becomes too biased in the negative direction and in particular, field curvature becomes difficult to correct. On the other hand, above the upper limit of conditional expression (4), the overall length of the second lens group becomes too long, causing the overall length of zoom lens to increase.

By satisfying conditional expression (4) within the following range, even more favorable results can be expected.

0.05<Dp/L2<0.12 (4a)

By satisfying the range prescribed by conditional expression (4a), the overall length of the second lens group can be further shortened and various types of aberration can be corrected more favorably.

Further, in the zoom lens according to the present invention, the following condition is preferably satisfied, where ud21 is the Abbe number for the d-line of the positive lens arranged farthest on the object side of the second lens group.

υd21>63 (5)

Conditional expression (5) prescribes a condition for favorably correcting over the entire zoom range, chromatic aberration occurring with respect to light of the visible light range to the near infrared light range. By forming the positive lens disposed farthest on the object side of the second lens group, of a low dispersion material that satisfies conditional expression (5), over the entire zoom range, chromatic aberration occurring with respect to light of the visible light range to the near infrared light range can be favorably corrected. Below the lower limit of conditional expression. (5), the correction of chromatic aberration on the axis becomes difficult and chromatic aberration occurring with respect to light of the visible light range to the near infrared light range cannot be sufficiently corrected.

Further, in the zoom lens according to the present invention, the first lens group is configured by 3 lenses arranged in 3 groups that include sequentially from the object side, a meniscus-shaped negative lens having a convex surface facing toward the object side, a biconcave-shaped negative lens, and a positive lens. By disposing farthest on the object side of the optical system, a meniscus lens that has a negative refractive power and a convex surface facing toward the object side, wide angle views are facilitated.

In addition, the following condition is preferably satisfied, where υd13 is the Abbe number of the 6-line of the positive ions in the first lens group.

υd1.3<20 (6)

Conditional expression (6) prescribes a condition for enabling chromatic aberration occurring within the first lens group to be corrected by the first lens group itself. in other words, by satisfying conditional expression (6), chromatic aberration on the axis and occurring consequent to the negative lenses in the first lens group and chromatic aberration consequent to zooming occur to the same extent as the aberration that is cor:secn to the positive lens and in the opposite direction of that of the negative lenses, enabling the chromatic aberration occurring overall in the first lens group to be corrected. Above the upper limit: of conditional expression (6), chromatic aberration at the positive lens cannot be caused to occur to the extent required for correction and as a result, the chromatic aberration occurring in the first lens group increases.

As described, the zoom lens according to the present iriventien satisfies the condfflons above and thereby, enables size reductions and higher zoom ratios to be achieved as well as high optical performance that enables use with a megapixel image sensor. In addition to achieving a larger aperture ratio, high optical performance is provided that over the entire zoom range, enables favorable correction of various types of aberration occurring with respect to light of the visible light range to the near infrared light range. By simultaneously satisfying multiple conditions, more favorable optical performance can be obtained than by satisfying 1 condition.

Hereinafter, embodiments of the zoom lens according to the present invention will be described in detail wilh reference to the drawings. The present invention is not limited by the embodiments below.

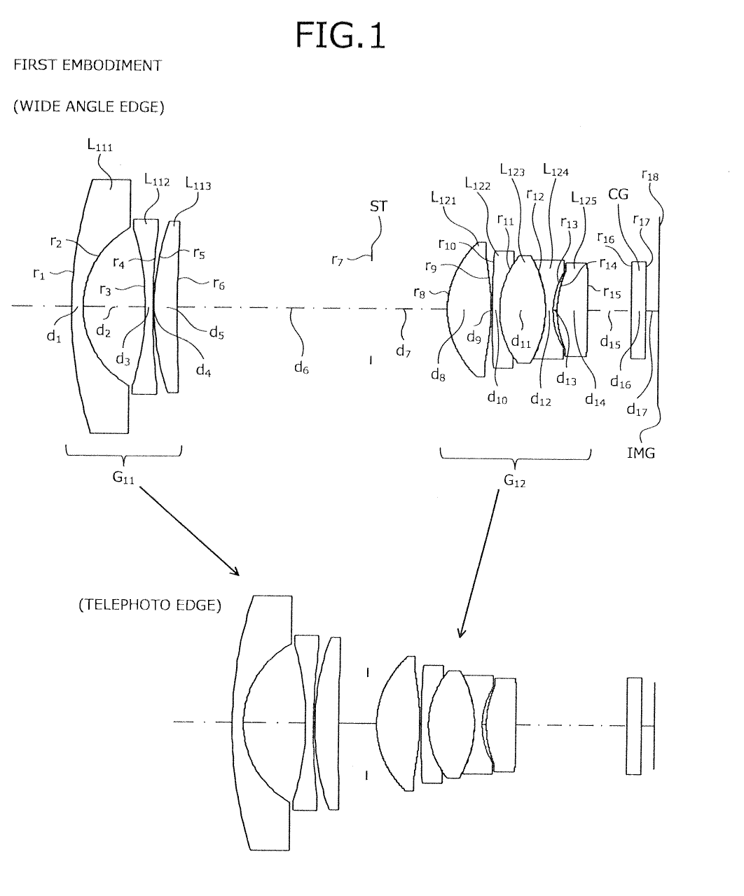

FIG. 1 is a cross sectional view (along the optical axis) of the zoom lens according to a first embodiment. The zoom lens includes sequentially from an object side facing toward an object (non-depicted), a first lens group G₁₁ having a negative refractive power, an aperture stop ST prescribing a given aperture, and a second lens group G₁₂ having a positive refractive power. A cover glass CG is disposed between the second lens group G₁₂ and an image plane IMG. The cover glass CG is disposed as necessary and may be omitted accordingly. At the image plane IMG, the light receiving surface of a solid state image sensor, such as a CCD and CMOS, is disposed.

The first lens group G₁₁ includes sequentially from the object side, a negative lens L₁₁₁, a negative lens L₁₁₂, and a positive lens L₁₁₃. The negative lens L₁₁₁ is configured by a meniscus Lens having a convex surface Lacing toward the object side. The negative lens L₁₁₂ is configured by a biconcave lens.

The second lens group G₁₂ includes sequentially from the object side, a positive lens L₁₂₁, a negative lens L₁₂₂, a positive lens L₁₂₂, a negative lens L₁₂₄, and a positive lens L₁₂₅. Roth surfaces of the positive lens L₁₂₁ are aspheric. The negative lens L₁₂₂, the positive lens L₁₂₃, and the negative lens L₁₂₄ are cemented. Both surfaces of the positive lens L₁₂₅ are aspheric.

In the zoom lens, the second lens group G₁₂ is moved along the optical axis toward the object side to zoom from the wide angle edge to the telephoto edge; and the first lens group G₁₁ is moved along the optical axis toward the image plane IMG, to correct image plane variation (imaging position) that accompanies zooming.

Here, various values related to the zoom lens according to the first embodiment are given.

Focal length of entire optical system of zoom
lens = 3.10(wide angle edge) to 8.65(telephoto edge)
F-number (Fno.) = 1.35(wide angle edge) to 2.22(telephoto
edge)
Angle of view (2ω) = 139.5(wide angle edge) to
44.5(telephoto edge)
Zoom ratio (Z) = 2.79
(Lens data)

| | | | |
|---|---|---|---|
| r₁ = 32.3570 | d₁ = 0.90 | nd₁ = 1.88100 | υd₁ = 40.14 |
| r₂ = 7.0357 | d₂ = 4.93 | | |
| r₃ = −20.3046 | d₃ = 0.60 | nd₂ = 1.69680 | υd₂ = 55.46 |
| r₄ = 52.9626 | d₄ = 0.10 | | |
| r₅ = 19.9083 | d₅ = 1.88 | nd₃ = 1.95906 | υd₃ = 17.47 |
| r₆ = 141.1846 | d₆ = D(6) (variable) | | |
| r₇ = ∞ | d₇ = D(7) (variable) | | |
| (aperture stop) | | | |
| r₈ = 6.5000 | d₈ = 3.47 | nd₄ = 1.61881 | υd₄ = 63.85 |
| (aspheric surface) | | | |
| r₉ = −14.9838 | d₉ = 0.10 | | |
| (aspheric surface) | | | |
| r₁₀ = 80.0537 | d₁₀ = 0.60 | nd₅ = 1.69895 | υd₅ = 30.05 |
| r₁₁ = 6.5000 | d₁₁ = 3.68 | nd₆ = 1.49700 | υd₆ = 81.61 |
| r₁₂ = −8.1250 | d₁₂ = 0.60 | nd₇ = 1.54814 | υd₇ = 45.82 |
| r₁₃ = 5.5000 | d₁₃ = 0.33 | | |
| r₁₄ = 7.3337 | d₁₄ = 2.41 | nd₈ = 1.74330 | υd₈ = 49.33 |
| (aspheric surface) | | | |
| r₁₅ = −162.1127 | d₁₅ = D(15) (variable) | | |
| (aspheric surface) | | | |
| r₁₆ = ∞ | d₁₆ = 1.20 | nd₉ = 1.51633 | υd₉ = 64.14 |
| r₁₇ = ∞ | d₁₇ = 1.00 | | |
| r₁₈ = ∞ | | | |
| (image plane) | | | |

Constants of the cone (K) and aspheric coefficients (A, B,
C, D)
(8th order)

| | |
|---|---|
| K = −0.5742, | |
| A = 2.3129 × 10⁻⁵, | B = 6.4387 × 10⁻⁷, |
| C = −1.0530 × 10⁻⁸, | D = 3.3380 × 10⁻⁹ |

(9th order)

| | |
|---|---|
| K = −14.5328, | |
| A = 2.4858 × 10⁻⁴, | B = −9.0271 × 10⁻⁶, |
| C = 3.6278 × 10⁻⁷, | D = −4.3932 × 10⁻⁹ |

(14th order)

| | |
|---|---|
| K = −3.5681, | |
| A = 1.9210 × 10⁻³, | B = −1.1573 × 10⁻⁴, |
| C = 6.4399 × 10⁻⁶, | D = −5.7187 × 10⁻⁷ |

(15th order)

| | |
|---|---|
| K = 0, A = 9.2492 × 10⁻⁴, | B = −7.1211 × 10⁻⁵, |
| C = 1.7807 × 10⁻⁶, | D = −2.8592 × 10⁻⁷ |

(Zoom data)

| | wide angle edge | telephoto edge |
|---|---|---|
| D(6) | 15.25 | 2.20 |
| D(7) | 6.10 | 0.80 |
| D(15) | 3.44 | 8.76 |

### (Values Related to Conditional Expression (1))

D2 (Amount of movement of second lens group G₁₂, accompanying zooming from wide angle edge to telephoto edge)=5.30

D2/Z=1.9

### (Values Related to Conditional Expression (2))

υd2p (Abbe number for d-line of positive lens L₁₂₃)=81.61

### (Values Related to Conditional Expression (3))

υd22 (Abbe number for d-line of negative lens L₁₂₃)/υd24 (Abbe number for d-line of negative L₁₂₄)=0.656

### (Values Related to Conditional Expression (4))

Dp (Interval between cemented lens and positive lens L₁₂₅ in Second lens group G₁₂)=0.33

L2 (Overall length of second Lens group G₁₂)=11.19

Dp/L2=0.0295

### (Values Related to Conditional Expression (5))

υd21 (Abbe number for d-line of positive lens L₁₂₁)=63.85

### (Values Related to Conditional Expression (6))

υd13 (Abbe number for d-line of positive lens L₁₁₂)=17.17

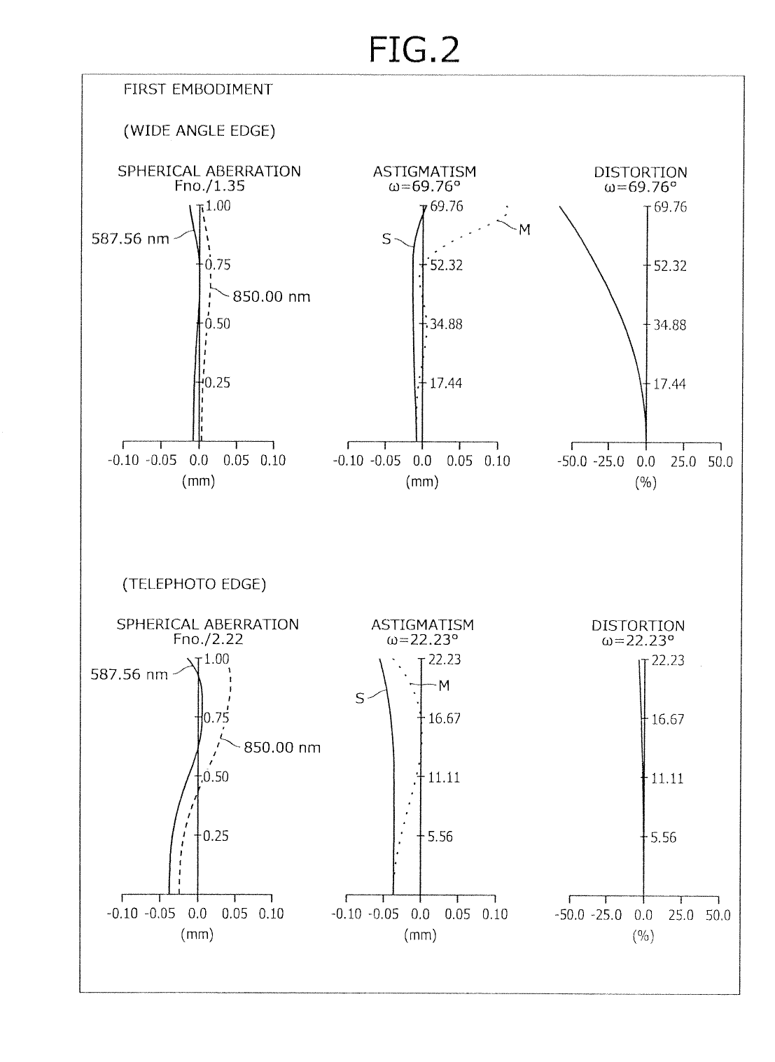

FIG. 2 is a diagram of various types of aberration occurring in the zoom lens according to the first embodiment. The figure depicts wavelength aberration for a Wavelength of 587.56 nm (d-line) and a wavelength of 850.00 rim (near infrared light range). S and M shown with respect to astigmatism, respectively indicate aberration at the sagittal image plane and at the meridonal image plane.

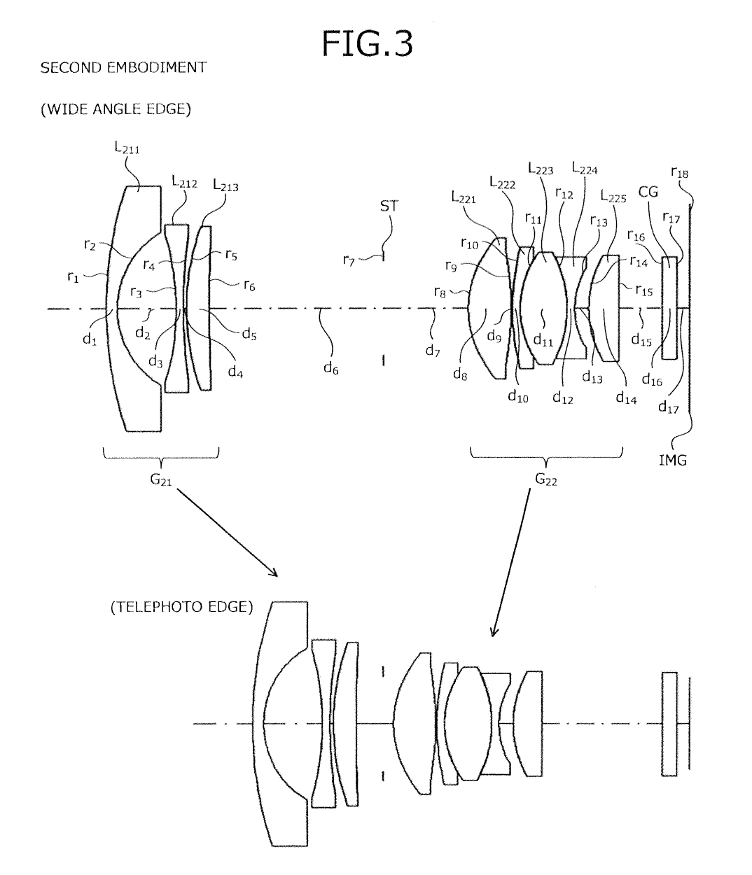

FIG. 3 is a cross sectional view (along the opical axis) of the zoom lens according to a second embodiment. The zoom lens includes sequentially from the object side, a first lens group G₂₁ having a negative refractive power, the aperture stop ST prescribing a given aperture, and a second lens group G₂₂ having a positive refractive power. The cover glass CG is disposed between the second lens group G₂₂ and the image plane IMG. The cover glass CG is disposed as necessary and may be omitted accordingly. At the image plane IMG, the light receiving surface of a sold state image sensor, such as a CCD and CMOS, is disposed.

The first lens group G₂₁ includes sequentially from the object side, a negative lens L₂₁₁, a negative lens L₂₁₂, and a positive lens L₂₁₃. The negative lens L₂₁₁ is configured by a meniscus lens having a convex surface facing toward the object side. The negative lens L₂₁₂ is configured by a biconcave lens.

The second lens group G₂₂ includes sequentially from the object side, a positive lens L₂₂₁, a negative lens L₂₂₂, a positive lens L₂₂₃, a negative lens L₂₂₄, and a positive lens L₂₂₅. Both surfaces of the positive lens L₂₂₁ are aspheric. The negative lens L₂₂₂, the positive lens L₂₂₃, and the negative lens L₂₂₄ are cemented. Both surfaces of the positive lens L₂₂₅ are aspheric.

In the zoom lens, the second lens croup G₂₂ is moved along the optical axis toward the object side to zoom from the wide angle edge to the telephoto edge; and the first lens group G₂₁ is moved along the optical axis toward the image plane IMG, to correct image plane variation (imaging position) that accompanies zooming.

Here, various values related to the zoom lens according to the second embodiment are given.

Focal length of entire optical system of zoom
lens = 3.10(wide angle edge) to 8.65 (telephoto edge)
F-number (Fno.) = 1.35 (wide angle edge) to 2.27 (telephoto
edge)
Angle of view (2ω) = 137.8(wide angle edge) to
44.8(telephoto edge)
Zoom ratio (Z) = 2.79
(Lens data)

| | | | |
|---|---|---|---|
| r₁ = 28.6250 | d₁ = 0.90 | nd₁ = 1.88100 | υd₁ = 40.14 |
| r₂ = 6.7499 | d₂ = 4.69 | | |
| r₃ = −19.1417 | d₃ = 0.60 | nd₂ = 1.69680 | υd₂ = 55.46 |
| r₄ = 37.2368 | d₄ = 0.25 | | |
| r₅ = 18.5538 | d₅ = 1.80 | nd₃ = 1.95906 | υd₃ = 17.47 |
| r₆ = 111.0681 | d₆ = D(6) (variable) | | |
| r₇ = ∞ | d₇ = D(7) (variable) | | |
| (aperture stop) | | | |
| r₈ = 7.2427 | d₈ = 3.40 | nd₄ = 1.61881 | υd₄ = 63.85 |
| (aspheric surface) | | | |
| r₉ = −18.6060 | d₉ = 0.10 | | |
| (aspheric surface) | | | |
| r₁₀ = 18.9270 | d₁₀ = 0.60 | nd₅ = 1.69895 | υd₅ = 30.05 |
| r₁₁ = 6.9000 | d₁₁ = 3.80 | nd₆ = 1.49700 | υd₆ = 81.61 |
| r₁₂ = −8.8110 | d₁₂ = 0.60 | nd₇ = 1.62004 | υd₇ = 36.30 |
| r₁₃ = 5.9000 | d₁₃ = 1.12 | | |
| r₁₄ = 8.2626 | d₁₄ = 2.40 | nd₈ = 1.74330 | υd₈ = 49.33 |
| (aspheric surface) | | | |
| r₁₅ = −48.0196 | d₁₅ = D(15) (variable) | | |
| (aspheric surface) | | | |
| r₁₆ = ∞ | d₁₆ = 1.20 | nd₉ = 1.51633 | υd₉ = 64.14 |
| r₁₇ = ∞ | d₁₇ = 1.00 | | |
| r₁₈ = ∞ | | | |
| (image plane) | | | |

Constants of the cone (K) and aspheric coefficients (A, B,
C, D)
(8th order)

| | |
|---|---|
| K = −0.6694, | |
| A = −1.9599 × 10⁻⁵, | B = −1.1027 × 10⁻⁶, |
| C = 1.0229 × 10⁻⁷, | D = −6.8191 × 10⁻¹⁰ |

(9th order)

| | |
|---|---|
| K = −6.5395, | |
| A = 2.8291 × 10⁻⁴, | B = −8.8130 × 10⁻⁶, |
| C = 3.2824 × 10⁻⁷, | D = −4.6912 × 10⁻⁹ |

(14th order)

| | |
|---|---|
| K = −5.7444, | |
| A = 1.8945 × 10⁻³, | B = −7.3437 × 10⁻³, |
| C = 3.9376 × 10⁻⁶, | D = −1.3730 × 10⁻⁷ |

(15th order)

| | |
|---|---|
| K = 0, | |
| A = 8.9125 × 10⁻⁴, | B = −4.9082 × 10⁻⁵, |
| C = 4.7040 × 10⁻⁶, | D = −1.9831 × 10⁻⁷ |

(Zoom data)

| | wide angle edge | telephoto edge |
|---|---|---|
| D(6) | 13.83 | 2.20 |
| D(7) | 6.86 | 0.80 |
| D(15) | 3.45 | 9.53 |

### (Values Related to Conditional Expression (1))

D2 (Amount of movement of second lens group G₂₂, accompanying zooming from wide angle edge to telephoto edge)=6.06

D2/Z=2.172

### (Values Related to Conditional Expression (2))

υd2p (Abbe number for d-line of positive lens L₂₂₃)=81.61

### (Values Related to Conditional Expression (3))

υd22 (Abbe number for d-line of negative lens L₂₂₂)/υd24(Abbe number for d-line of negative lens L₂₂₄)=0.828

### (Values Related to Conditional Expression (4))

Dp (Interval between cemented lens and positive lens L₂₂₅ in second lens group G22)=1.12

L2 (Overall length of second lens group G₂₂)=12.02

Dp/L2=0.093

### (Values Related to Conditional Expression (5))

υd21 (Abbe number for d-line of positive lens L₂₂₁)=63.85

### (Values Related to Conditional Expression (6))

υd13(Abbe number for d-line of positive lens L₂₁₃)=17.47

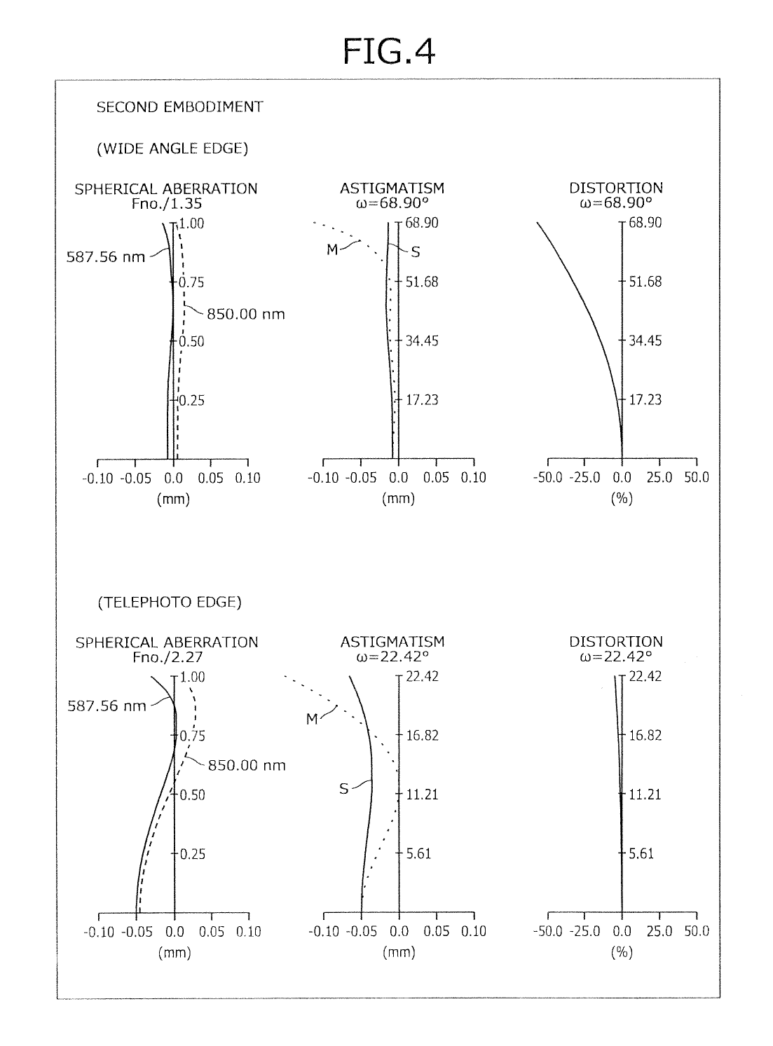

FIG. 4 is a diagram of various types of aberration occurring in the zoom lens according to the second embodiment. The figure depicts wavelength aberration for a wavelength of 587.56 nm (d-line) and a wavelength of 850.00 nm (near infrared light range). S and M shown with respect to astigmatism; respectively indicate aberration a: the sagittal image plane and at the meridonal image plane.

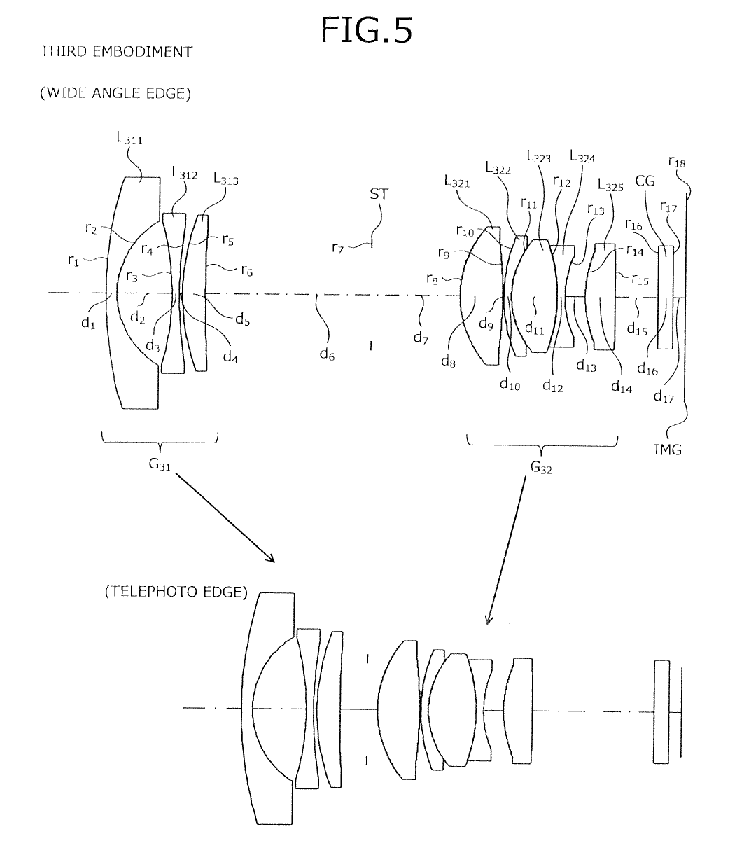

FIG. 5 is a cross sectional view (along the optical axis) of the zoom lens according to a third embodiment. The zoom lens includes sequentially from the object side, a first lens group G₃₁ having a negative refractive power, the aperture stop ST prescribing a given aperture, and a second lens group G₃₂ having a positive refractive power. The cover glass CG is disposed between the second lens group G₃₂ and the image plane IMG. The cover glass CG is disposed as necessary and may be omitted accordingly. At the image plane IMG, the light receiving surface of a solid state image sensor, such as a CCD and CMOS, is disposed.

The first lens group G₃₁ includes sequentially from the object side, a negative lens L₃₁₁, a negative lens L₃₁₂, and a positive lens L₃₁₃. The negative lens L₃₁₁ is configured by a meniscus lens having a convex surface facing toward the object side. The negative lens L₃₁₂ is configured by a biconcave lens.

The second lens group G₃₂ includes sequentially from the object side, a positive lens L₃₂₁, a negative lens L₃₂₂, a positive lens L₃₂₃, a negative lens L₃₂₄, and a positive lens L₃₂₅. Both surfaces of the positive lens L₃₂₁ are aspheric. The negative lens L₃₂₂, the positive lens and the neoative lens L₃₂₄ are cemented. Both suraces or the positive lens L₃₂₅ are aspheric.

In the zoom lens, the second lens group G32 is moved along the optical axis toward the object side to zoom from the wide angle edge to the telephoto edge; and the first lens group G₃₁ is moved along the optical axis toward the image plane IMG, to correct image plane variation (imaging position) that accompanies zooming.

Here, various values related to the zoom lens according to the third embodiment are given.

Focal length of entire optical system of zoom
lens = 3.10(wide angle edge) to 8.65(telephoto edge)
F-number (Fno.) = 1.35(wide angle edge) to 2.27(telephoto
edge)
Angle of view (2ω) = 139.2(wide angle edge) to
45.0(telephoto edge)
Zoom ratio (Z) = 2.79
(Lens data)

| | | | |
|---|---|---|---|
| r₁ = 31.1372 | d₁ = 0.90 | nd₁ = 1.88100 | υd₁ = 40.14 |
| r₂ = 6.6424 | d₂ = 4.37 | | |
| r₃ = −19.8116 | d₃ = 0.60 | nd₂ = 1.69680 | υd₂ = 55.46 |
| r₄ = 35.2194 | d₄ = 0.25 | | |
| r₅ = 17.2773 | d₅ = 1.80 | nd₃ = 1.94594 | υd₃ = 17.98 |
| r₆ = 88.8758 | d₆ = D(6) (variable) | | |
| r₇ = ∞ | d₇ = D(7) (variable) | | |
| (aperture stop) | | | |
| r₈ = 7.8857 | d₈ = 3.40 | nd₄ = 1.61881 | υd₄ = 63.85 |
| (aspheric surface) | | | |
| r₉ = −28.3972 | d₉ = 0.10 | | |
| (aspheric surface) | | | |
| r₁₀ = 12.3684 | d₁₀ = 0.60 | nd₅ = 1.69895 | υd₅ = 30.05 |
| r₁₁ = 6.5000 | d₁₁ = 3.80 | nd₆ = 1.49700 | υd₆ = 81.61 |
| r₁₂ = −12.5484 | d₁₂ = 0.60 | nd₇ = 1.67270 | υd₇ = 32.17 |
| r₁₃ = 7.6921 | d₁₃ = 1.63 | | |
| r₁₄ = 9.0202 | d₁₄ = 2.40 | nd₈ = 1.74330 | υd₈ = 49.33 |
| (aspheric surface) | | | |
| r₁₅ = −87.6394 | d₁₅ = D(15) (variable) | | |
| (aspheric surface) | | | |
| r₁₆ = ∞ | d₁₆ = 1.20 | nd₉ = 1.51633 | υd₉ = 64.14 |
| r₁₇ = ∞ | d₁₇ = 1.00 | | |
| r₁₈ = ∞ | | | |
| (image plane) | | | |

Constants of the cone (K) and aspheric coefficients (A, B,
C, D)
(8th order)

| | |
|---|---|
| K = −0.6133, | |
| A = 1.7513 × 10⁻⁶, | B = −1.7488 × 10⁻⁶, |
| C = 1.4786 × 10⁻⁷, | D = −1.4764 × 10⁻⁹ |

(9th order)

| | |
|---|---|
| K = 0.2439, | |
| A = 2.4387 × 10⁻⁴, | B = −6.2756 × 10⁻⁶, |
| C = 3.2083 × 10⁻⁷, | D = −5.0726 × 10⁻⁹ |

(14th order)

| | |
|---|---|
| K = −7.8516, | |
| A = 1.5681 × 10⁻³, | B = −8.1838 × 10⁻⁵, |
| C = 3.7026 × 10⁻⁶, | D = −1.5052 × 10⁻⁷ |

(15th order)

| | |
|---|---|
| K = 0, | |
| A = 7.1700 × 10⁻⁴, | B = −4.2843 × 10⁻⁵, |
| C = 2.6181 × 10⁻⁶, | D = −1.3743 × 10⁻⁷ |

(Zoom data)

| | wide angle edge | telephoto edge |
|---|---|---|
| D(6) | 13.39 | 2.20 |
| D(7) | 7.11 | 0.80 |
| D(15) | 3.44 | 9.80 |

### (Values Related to Conditional Expression (1))

D2 (Amount of movement of second lens group G₃₂, accompanying zooming from wide angle edge to telephoto edge)=6.31

D2/Z=2.261

### (Values Related to Conditional Expression (2))

υd2p (Abbe number for d-line pf positive Lens L₃₂₃)=81.61

### (Values Related to Conditional Expression (3))

υd22 (Abbe number for d-line of negative lens L₃₂₂)/υd24(Abbe number for d-line of negative lens L₃₂₄)=0.934

### (Values Related to Conditional Expression (4))

Dp (Interval between cemented lens and positive lens L₃₂₅ in second lens group G₃₂)=1.63

L2 (Overall length of second lens group G₃₂)=12.53

Dp/L2=0.13

### (Values Related to Conditional Expression (5))

υd21 (Abbe number for d-line of costtive lens L₃₂₁)=63.85

### (Values Related to Conditional Expression (6)

υd13 (Abbe number for d-line of positive lens L₃₁₃)=17.98

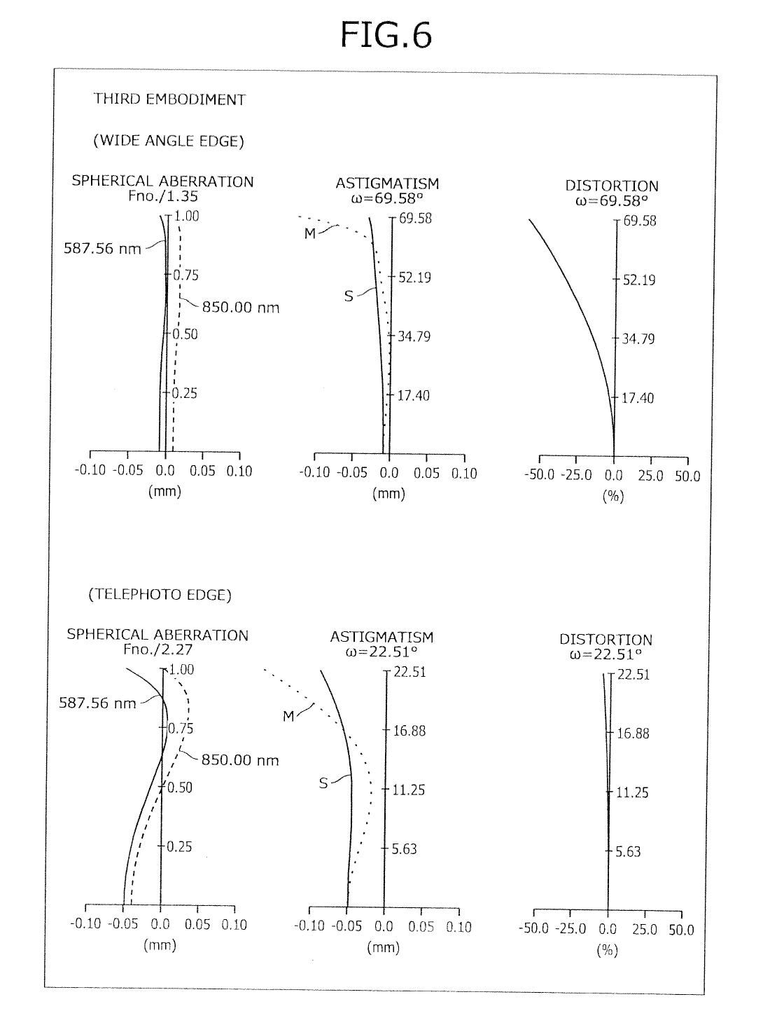

FIG. 6 is a diagram of various types of aberration occurring in the zoom lens according to the third embodiment. The figure depicts wavelength aberration for a wavelength of 587.56 nm (d-line) and a wavelength of 850.00 nm (near infrared light range). S and M shown with respect to astigmatism, respectively indicate aberration at the sagittal image plane and at the meridonal image plane.

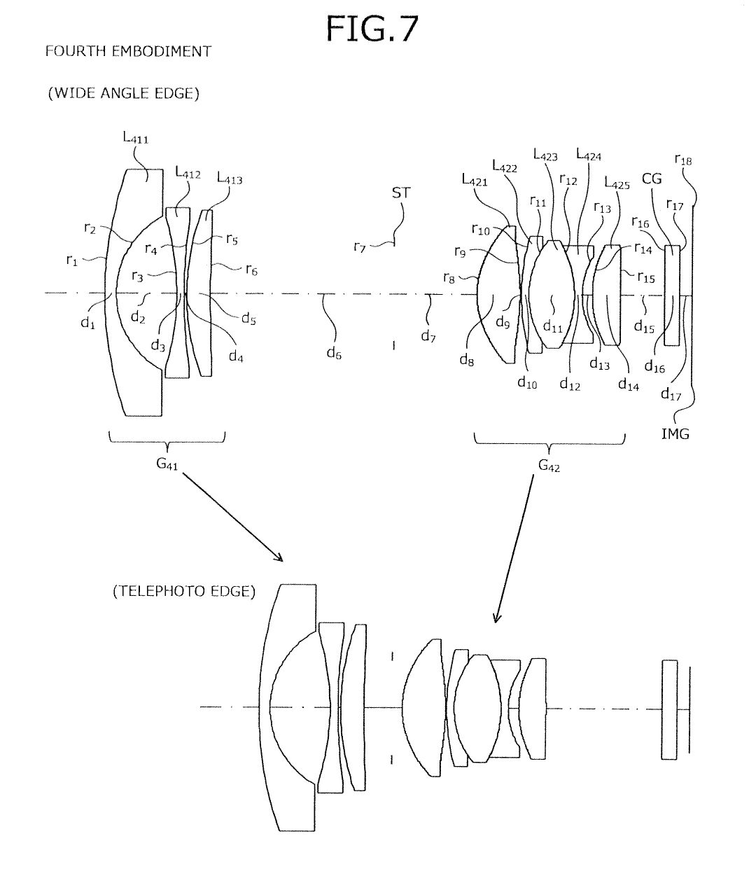

FIG. 7 is a cross sectional view (along the optical axis) oft the zoom lens according to a fourth embodiment. The zoom lens includes sequentially from the object side, a first lens group G₄₁ having a negative refractive power, the aperture stop ST prescribing a given aperture, and a second lens group G₄₂ having a positive refractive power. The cover glass CG is disposed between the second lens group G₄₂ and the image plane IMG. The cover glass CG is disposed as necessary and may be omitted accordingly. At the image plane IMG, the light receiving surface of a solid state image sensor, such as a CCD and CMOS, is disposed.

The first lens group G₄₁ includes sequentially from the object side, a negative lens L₄₁₁, a negative lens L₄₁₂, and a positive lens L₄₁₃. The negative lens L₄₁₁ is configured by a meniscus lens having a convex surface facing toward the object side. The negative lens L₄₁₂ is configured by a biconcave lens.

The second lens group G₄₂ includes sequentially from the object side, a positive lens L₄₂₁, a negative lens L₄₂₂, a positive lens L₄₂₃, a negative lens L₄₂₄, and a positive lens L_{425.} Both surfaces of the positive lens L₄₂₁ are aspheric. The negative lens L₄₂₂, the positive lens L₄₂₃, and the negative lens L₄₂₄ are cemented. Both surfaces of the positive lens L₄₂₅ are aspheric.

In the zoom lens, the second lens group is moved aong the optical axis toward the object side to zoom from the wide angle edge to the telephoto edge; and the first lens group G₄ is moved along the optical axis toward the image plane IMG, to correct image plane variation (imaging position) that accompanies zooming.

Here, various values related to the zoom lens according to the fourth embodiment are given.

Focal length of entire optical system of zoom lens = 3.10(wide
angle edge) to 8.65(telephoto edge)
F-number (Fno.) = 1.35(wide angle edge) to 2.25(telephoto edge)
Angle of view (2ω) = 132.9(wide angle edge) to 43.4(telephoto edge)
Zoom ratio (Z) = 2.79
(Lens data)

| r₁ = 28.5445 | | |
|---|---|---|
| d₁ = 0.90 | nd₁ = 1.88100 | νd₁ = 40.14 |
| r₂ = 6.8556 | | |
| d₂ = 4.80 | | |
| r₃ = −19.2406 | | |
| d₃ = 0.60 | nd₂ = 1.69680 | νd₂ = 55.46 |
| r₄ = 40.6322 | | |
| d₄ = 0.21 | | |
| r₅ = 19.27151 | | |
| d₅ = 1.84 | nd₃ = 1.95906 | νd₃ = 17.47 |
| r₆ = 138.1909 | | |
| d₆ = D(6) (variable) | | |
| r₇ = ∞(aperture stop) | | |
| d₇ = D(7) (variable) | | |
| r₈ = 6.7845 (aspheric surface) | | |
| d₈ = 3.41 | nd₄ = 1.61881 | νd₄ = 63.85 |
| r₉ = −18.1023 (aspheric surface) | | |
| d₉ = 0.10 | | |
| r₁₀ = 16.6622 | | |
| d₁₀ = 0.60 | nd₅ = 1.74077 | νd₅ = 27.76 |
| r₁₁ = 6.5000 | | |
| d₁₁ = 3.73 | nd₆ = 1.43700 | νd₆ = 95.10 |
| r₁₂ = −8.1250 | | |
| d₁₂ = 0.60 | nd₇ = 1.62004 | νd₇ = 36.30 |
| r₁₃ = 5.6971 | | |
| d₁₃ = 0.81 | | |
| r₁₄ = 8.2963 (aspheric surface) | | |
| d₁₄ = 2.27 | nd₉ = 1.85135 | νd₈ = 40.10 |
| r₁₅ = −51.7702 (aspheric surface) | | |
| d₁₅ = D(15) (variable) | | |
| r₁₆ = ∞ | | |
| d₁₆ = 1.20 | nd₉ = 1.51633 | νd₉ = 64.14 |

r₁₇ = ∞
d₁₇ = 1.00
r₁₈ = ∞ (image plane)

Constants of the cone (K) and aspheric coefficients (A, B, C, D)

(8th order)
K = −0.6411,
A = −1.2907 × 10⁻⁵, B = −3.0165 × 10⁻⁷,
C = 5.8368 × 10⁻⁸, D = 1.2429 × 10⁻⁹
(9th order)
K = −10.2669,
A = 2.9490 × 10⁻⁴, B = −1.0692 × 10⁻⁵,
C = 4.2305 × 10⁻⁷, D = −5.6209 × 10⁻⁹
(14th order)
K = −4.6171,
A = 1.8431 × 10⁻³, B = −8.1953 × 10⁻⁵,
C = 5.8019 × 10⁻⁶, D = −2.6181 × 10⁻⁷
(15th order)
K = 0,
A = 9.9504 × 10⁻⁴, B = −6.9057 × 10⁻⁵,
C = 7.1792 × 10⁻⁶, D = −3.5462 ×× 10⁻⁷

(Zoom data)

| | wide angle edge | telephoto edge |
|---|---|---|
| D(6) | 14.53 | 2.20 |
| D(7) | 6.55 | 0.80 |
| D(15) | 3.46 | 9.21 |

### (Values Related to Conditional Expression (1))

D2 (Amount of movement of second lens group G₄₂, accompanying zooming from wide angle edge to telephoto edge)=5.75

D2/Z=2.061

### (Values Related to Conditional Expression (2))

υd2p (Abbe number for d-line of positive lens L₄₂₃)=95.1

### (Values Related to Conditional Expression (3))

υd22 (Abbe number for d-line of negative lens L₄₂₃)/υd24(Abbe number for d-line (negative lens L₄₂₄)=0.765

### (Values Related to Conditional Expression (4))

Dp (Interval between cemented lens and positive lens L₄₂₅ in second lens group G₄₂)=0.81

L2 (Overall length of second lens group G₄₂)=11.52

Dp/L2=0.07

### (Values Related to Conditional Expression (5))

υd21 (Abbe number for d-line of positive lens L₄₂₁)=63.85

### (Values Related to Conditional Expression (6))

υd13 (Abbe number for d-line of positive lens L₄₁₃)=17.47

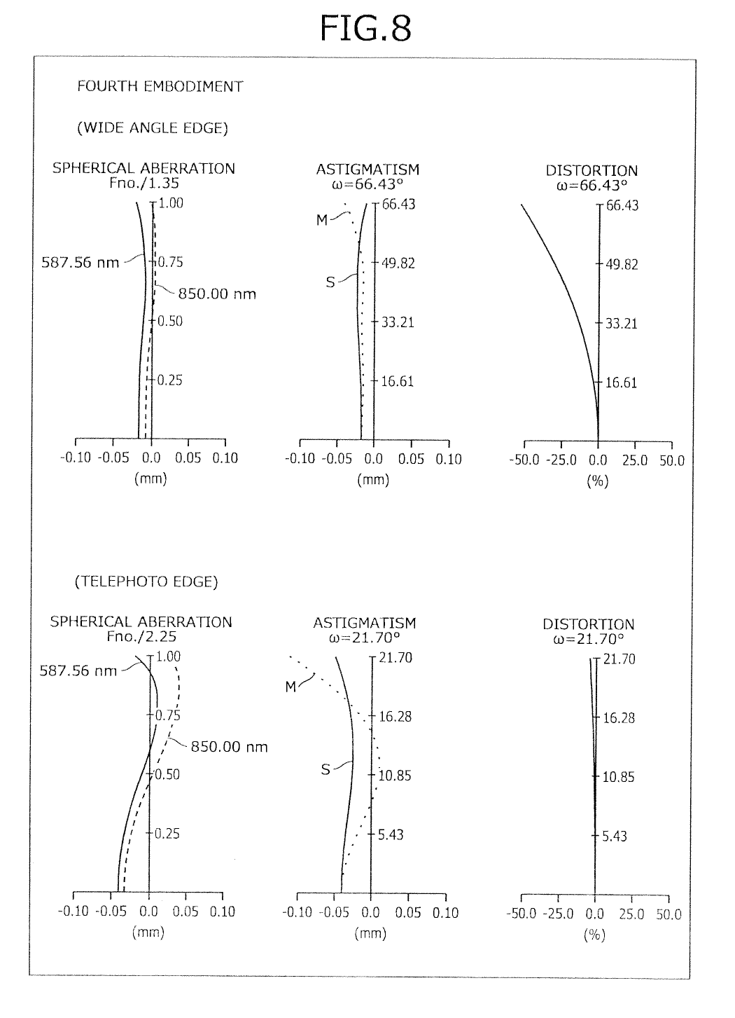

FIG. 8 is a diagram of various types of aberration occurring in the zoom lens according to the fourth embodiment. The figure depicts wavelength aberration for a wavelength of 587.56 nm (d-line) and a wavelength of 850.00 nm (near infrared light range). S and M shown with respect to astigmatism, respectively indicate aberration at the sagittal image plane and at the meri.donal image plane.

Among the values for each of the embodiments, r₁, r₂, . . . indicate the radius of curvature of lens surfaces, diaphragm surface, etc.; d₁, d₂, . . . indicate the thickness of the lenses, the diaphragm, etc. or the interval between the surfaces thereof; nd₁, nd₂, . . . indicate the retraction index of the lenses with respect to the d-line (λ=587.56 nm); and ud₁, ud₂, . . . indicate the Abbe number for the d-line (λ=587.56 nm). Lengths are indicated in units of “mm”; and angles are indicated in “degrees”.

Each aspheric surface shape above is expressed by equation [1], where Z is a distance along the direction of the optical axis, from the apex of the lens surface; y is a height in a direction orthogonal to the optical axis; R is paraxial radius of curvature; K is the constant of the cone; A, B, C, and D are fourth, sixth, eighth, and tenth order aspheric coefficients, respectively; and the travel direction of light is positive.

$$Z = \frac{{y}^{2}}{{R ( 1 + \sqrt{1 - ( 1 + K ) y \text{/} {R}^{2}} )}^{2}} + {Ay}^{4} + {By}^{6} + {Cy}^{8} + {Dy}^{10}$$

As described, the zoom lens of each of the embodiments satisfies each of the conditions above, enabling size reductions and higher zoom ratios to be achieved as well as high optical performance that enables use with a megapixel image sensor. In addition to achieving a large aperture ratio, high optical performance is provided that over the entire zoom range, enables favorable correction of various types of aberration occurring with respect to light from the visible light range to the near infrared light range. Consequently, the zoom lens is optimal for video cameras such as compact surveillance cameras (particularly, surveillance dome cameras) equipped with a megapixel image sensor. The zoom lens of the embodiments uses lenses having properly shaped aspheric surfaces and thereby, enables favorable optical performance to be maintained with fewer lenses.

According to the present invention, a zoom lens can be provided that achieves size reductions and higher zoom ratios as well as high optical performance that enables ese with megapixel image sensors.

According to the present invention, a zoom lens can be provided that achieves a larger aperture ratio and has high optical performance that enables over the entire zoom range, favorable correction of various types of aberration occurring with respect to light of the visible light reuse to the near infrared light range.

According to the present invention, a zoom lens can be provided that reduces the overall length of the second lens group and has high optical performance that in second lens group, enables a proper balance of the Petzval sum to be maintalned while further enabling various types of aberration to be favorable corrected.

According to the present invention, a zoom lens can be provided that achieves size reductions and a higher zoom ratio as well as high optical performance that enables use with megapixel image sensors. The zoom lens further achieves a larger aperture ratio and has high optical performance that enables over the entire zoom range, the correction of various types of aberration occurring with respect to light of the visible light range to the near in light range.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

The present document incorporates by reference the entire contents of Japanese priority document, 2013-220934 filed in Japan on Oct. 24, 2013.

What is claimed is:

1. A zoom lens comprising sequentially from an object side:
a first lens group having a negative refractive power;
an aperture stop; and
a second lens group having a positive refractive power, wherein
the second lens group is moved a lung an optical axis toward the object side to zoom from a wide angle edge to a telephoto edge,
the first lens group is moved along the optical axis toward an image side to correct image plane variation that accompanies zooming,
the second lens group includes sequentially from the object side, a positive lens having at least one asoheric surface, and a cemented lens configured by a negative lens, a positive lens, and a negative lens, and
the zoom lens satisfies a conditional expression (1) 1.8<D2/Z<2.3, where D2 indicates an amount of movement of:
the second lens group, accompanying the zooming from the wide angle edge to the telephoto edge, and Z indicates a zoom ratio (focal length at telephoto edgefocal length at wide angle edge).

2. The zoom lens according to claim 1, wherein
the zoom lens satisfies a conditional expression (2) υd2p>80 and a conditional expression, (3) 0.6<υd22/υd24<1, where υd2p indicates an Abbe number for a d-line of the positive lens configuring the cemented lens of the second lens group, υd22 indicates the Abbe number for the d-line of the negative lens disposed farthest on the object side in the cemented lens of the second lens group, and υd24 indicates the Abbe number for the d-line of the negative lens disposed farthest on the image side in the cemented lens of the second lens group.

3. The zoom lens according to claim 1, further comprising
a positive lens disposed on the image side of the cemented lens of the second lens group, wherein
the zoom lens satisfies a conditonal expression (4) 0.2<Dp/L2<0.15, where Pp indicates an interval between the cemented lens and the positive lens disposed on the image side of the cemented lens, and L2 indicates an overall length of the second lens group.

4. The zoom lens according to claim 2, further comprising
a positive lens disposed on the image side of the cemented lens of the second ens group, wherein
the zoom lens satisfies a conditional expression (4) 0.2<Dp/L2<0.15, where Dp indicates an interval between the cemented lens and the positive lens disposed on the image side of the cemented lens, and L2 indicates an overall length of the second lens group.
